(19) United States
(12) Patent Application Publication
(10) Pub. No.: US 2004/0169580 A1
(43) Pub. Date: Sep. 2, 2004

(54) Touch panel apparatus

(75) Inventors: Kyungwoo Kim, Yokkaichi-city (JP); Yoshihiko Gotoh, Yokkaichi-city (JP)

Correspondence Address: OLIFF & BERRIDGE, PLC, P.O. BOX 19928, ALEXANDRIA, VA, 22320, US

(73) Assignee: SUMITOMO WIRING SYSTEMS, LTD., YOKKAICHI-CITY (JP)

(21) Appl. No.: 10/694,757

(22) Filed: Oct. 29, 2003

(30) Foreign Application Priority Data
Feb. 28, 2003 (JP) 2003-052952

(51) Int. Cl. H01C 1/02

(52) U.S. Cl. 338/227

(57) ABSTRACT

A touch panel apparatus includes a liquid crystal display device including a liquid crystal section, an illuminating section disposed at a rear side of the liquid crystal section for illuminating the liquid crystal section, and a frame section disposed on an outer periphery of the liquid crystal section; a transparent resistive membrane type of touch panel disposed at a front side of the liquid crystal display device; and a spacer member disposed between the frame section of the liquid crystal display device and a periphery of the touch panel for defining a clearance between the liquid crystal section of the liquid crystal display device and the touch panel. The spacer member covers an area from a front surface of the frame section of the liquid crystal display device to a periphery of a front surface of the liquid crystal section while maintaining the clearance between the liquid crystal section and the liquid crystal display device.

### CLAIM FOR PRIORITY

The present invention claims priority to Japanese Patent Applications JP-A-2003-052952 filed Feb. 28, 2003.

### BACKGROUND OF THE INVENTION

1. Field of Invention

This invention relates to a resistive membrane type of touch panel apparatus to be used for a display device or the like mounted in an automobile vehicle.

2. Description of Related Art

For convenience of explanation, a conventional touch panel apparatus will be described by referring to FIGS. 1 and 4. FIG. 1 is a general perspective view of a conventional touch panel apparatus. FIG. 4 is a cross section view taken along line IV-IV in FIG. 1.

For example, a conventional touch panel apparatus 100, as shown in FIGS. 1 and 4, has been known in Japanese Patent Public Disclosure 2000-222162. The touch panel apparatus 100 includes a liquid crystal display device 3 including a liquid crystal section 13, an illuminating section 15 disposed at a rear side of the liquid crystal section 13 for illuminating it, and a frame section 17 disposed on an outer periphery of the liquid crystal section 13; a transparent resistive membrane type of touch panel 5 disposed at a front side of the liquid crystal display device 3; and a spacer member 107 disposed between the frame section 17 of the liquid crystal display device 3 and a periphery of the touch panel 5 for defining a clearance between the liquid crystal section 13 of the liquid crystal display device 3 and the touch panel 5. An element 9 in FIGS. 1 and 4 is a cover for containing the touch panel 5 and liquid crystal display device 3.

In the conventional touch panel apparatus 100, since the spacer member 107 defines the clearance between the liquid crystal section 13 and the touch panel 5, the spacer member 107 prevents the touch panel 5 from being deflected rearward to contact with the liquid crystal section 13 upon touch operation onto the touch panel 5.

The conventional touch panel apparatus 100 prevents a failure in display in the liquid crystal section 13. The spacer member 107 is spaced away from the liquid crystal section 13 so that the spacer member 107 does not contact with a periphery of the liquid crystal section 13.

Consequently, lights S from the illuminating section 15 leak from an outer periphery of the liquid crystal section 13 (for example, a clearance between the liquid crystal section 13 and the frame section 17) to a front side of the liquid crystal section 13. This will deteriorate a display design of the liquid crystal section 13 at nighttime.

The conventional touch panel apparatus 100 prevents a failure in display in the liquid crystal section 13. The spacer member 107 is spaced away from the liquid crystal section 13 so that the spacer member 107 does not contact with a periphery of the liquid crystal section 13.

Consequently, lights S from the illuminating section 15 leak from an outer periphery of the liquid crystal section 13 (for example, a clearance between the liquid crystal section 13 and the frame section 17) to a front side of the liquid crystal section 13. This will deteriorate a display design of the liquid crystal section 13 at nighttime.

### SUMMARY OF THE INVENTION

Accordingly, an object of the present invention is to provide a touch panel apparatus that can prevent a liquid crystal section from causing a failure in display on account of contact between a spacer member and the liquid crystal section and can prevent lights from an illuminating section from leaking through an outer periphery of the liquid crystal section (for example, a clearance between a liquid crystal section of liquid crystal display device and a frame section) to a front side of the liquid crystal section.

In order to solve the above problems, the first aspect in the embodiments of the invention is directed to a touch panel apparatus including a liquid crystal display device including a liquid crystal section, an illuminating section disposed at a rear side of the liquid crystal section for illuminating the liquid crystal section, and a frame section disposed on an outer periphery of the liquid crystal section; a transparent resistive membrane type of touch panel disposed at a front side of the liquid crystal display device; and a spacer member disposed between the frame section of the liquid crystal display device and a periphery of the touch panel for defining a clearance between the liquid crystal section of the liquid crystal display device and the touch panel. The spacer member covers an area from a front surface of the frame section of the liquid crystal display device to a periphery of a front surface of the liquid crystal section while maintaining the clearance between the liquid crystal section and the liquid crystal display device.

In the second aspect in the embodiments of the invention, a portion of the spacer member that covers the liquid crystal section is provided in a rear surface with a recess for defining a clearance between the spacer member and the liquid crystal section.

In the third aspect in the embodiments of of the invention, a portion of the spacer member that covers the liquid crystal section is provided in a front surface with a recess for defining a clearance between the spacer member and the touch panel.

In the fourth aspect in the embodiments of the invention, the spacer member is formed to expose only a display area on a front surface of the liquid crystal section and to cover a periphery of the front surface.

In the fifth aspect in the embodiments of the invention, a lower positioning wall projects from a rear surface of the spacer member to engage an outer peripheral side surface of the frame section of the liquid crystal display device, thereby positioning the frame section with respective to the rear surface of the spacer member.

In the sixth aspect in the embodiments of the invention, an upper positioning wall projects from the front surface of the spacer member to engage an outer peripheral side surface of the touch panel, thereby positioning the touch panel with respect to the front surface of the spacer member.

### BRIEF DESCRIPTION OF THE DRAWINGS

The features of the present invention believed to be novel and the elements characteristic of the present invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a general perspective view of an embodiment of a touch panel apparatus in accordance with the present invention and also a general perspective view of a conventional touch panel apparatus;

FIG. 2 is a cross section taken along line 1′-11 in FIG. 1, illustrating the embodiment of the touch panel apparatus in accordance with the present invention;

FIG. 3 is an enlarged cross section of a part of a spacer member shown in FIG. 2; and

FIG. 4 is a cross section view taken along line IV-IV in FIG. 1, illustrating the conventional touch panel apparatus.

### DETAILED DESCRIPTION OF PREFERRED EMBODIMENTS

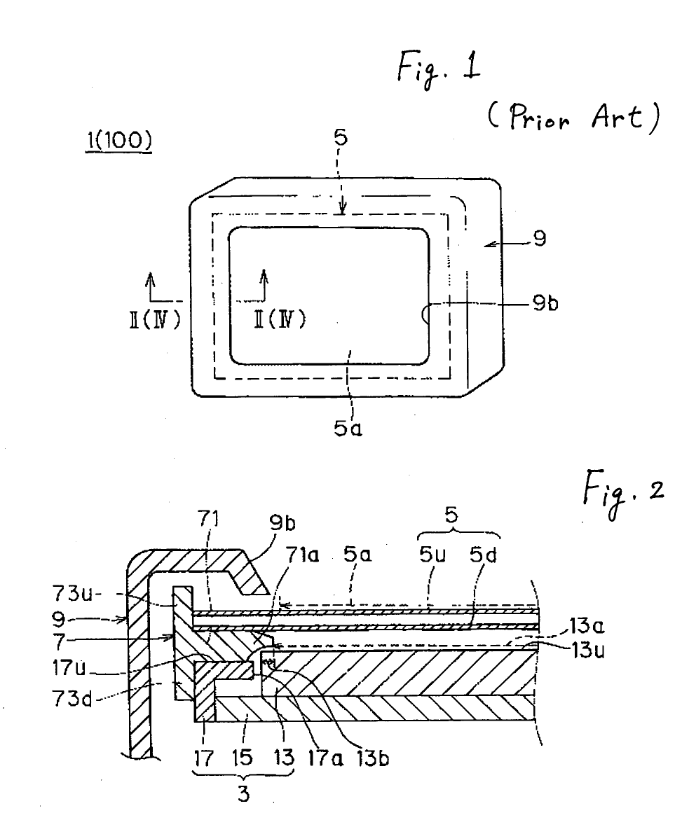

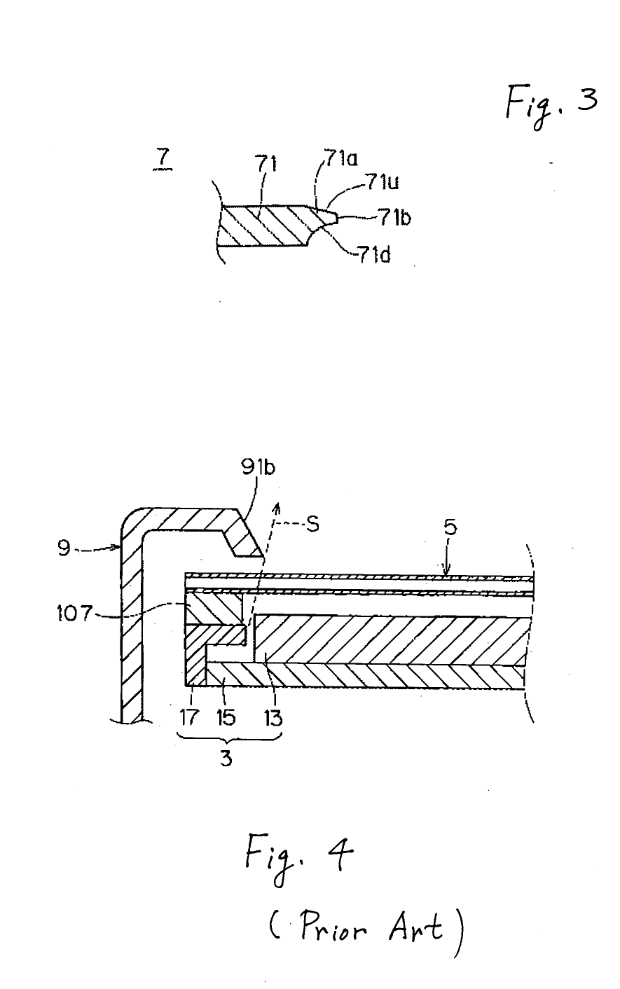

Referring now to the drawings, an embodiment of a touch panel apparatus in accordance with the present invention will be described below. FIG. 1 is a general perspective view of an embodiment of a touch panel apparatus in accordance with the present invention. FIG. 2 is a cross section taken along line II-II in FIG. 1. FIG. 3 is an enlarged cross section of a part of a spacer member shown in FIG. 2.

A touch panel apparatus 1 in this embodiment, as shown in FIGS. 1 and 2, includes a liquid crystal display device 3 on which an image for a touch operation is displayed; a transparent resistive membrane type of touch panel 5 disposed at a front side of the liquid crystal display device 3 for detecting an touch operation to an image for a touch operation displayed on the liquid crystal display device 3; a spacer member 7 disposed between the liquid crystal display device 3 and the touch panel 5; and a containing cover 9 for accommodating the respective elements 3, 5, and 7 so that an action area 5a on the touch panel 5 is exposed from a central front window 9b in the cover 9.

The liquid crystal display device 3 includes a liquid crystal section 13 for generating an image for a touch operation, an illuminating section 15 disposed at a rear side of the liquid crystal section 13 for illuminating the image for the touch operation generated on the liquid crystal section 13, and a frame section 17 disposed on an outer periphery of the liquid crystal section 13. The frame section 17 is provided as a containing case for accommodating the liquid crystal section 13 and illustrating section 15 so that the frame section 17 exposes a front surface 13u of the liquid crystal section 13 through an opening 17a formed in a central part of the front surface 17u of the frame section 17. In this embodiment, for example, the front surface 13u of the liquid crystal section 13 projects forward through the opening 17a in the frame section 17 from the front surface 17u of the frame section 17.

The touch panel 5 includes a front conductive transparent sheet 5u and a rear conductive transparent sheet 5d. The sheets 5u and 5d are opposed to and spaced away from each other at a given distance. The front conductive sheet 5u and the rear conductive sheet 5d each includes a transparent sheet member (not shown) and a transparent electrode (not shown) formed on a rear surface of the transparent sheet member in, for example, a so-called matrix type or analogue type forming pattern. In this embodiment, an action area 5a on the touch panel 5 is set to be, for example, within a display area 13a of the liquid crystal section 13 of the liquid crystal device 3.

In the above construction, when a touch operation is performed on the touch panel 5 at the front side, a touch pressure at the touch position brings the respective conductive transparent sheets 5u and 5d into a local short circuit. The short circuit position (touch position) on the touch panel 5 is detected by a detecting device (not shown) in accordance with a detecting principle corresponding to the type (matrix type or analogue type) of the forming pattern. Thus, the touch operation onto the touch panel 5 (that is, touch operation onto an image for a touch operation displayed on the liquid crystal device 3) can be detected.

The spacer member 7 is made of, for example, a resin material or an elastic material. The spacer member 7 covers a periphery 13b of the front surface 13u of the liquid crystal section 13 from the front surface 17u of the frame section 17 of the liquid crystal display device 3 so that the spacer member 7 is spaced away from the liquid crystal section 13 and does not extend within the display area 13a on the front surface 13u of the liquid crystal section 13 and the action area 5a on the touch panel 5.

In more detail, the spacer member 7, as shown in FIG. 2, includes a plate-like spacer body 71 having a frame-like configuration in a plan view. The spacer body 71 covers an area from the front surface 17u of the frame section 17 of the liquid crystal display device 3 to the periphery 13b of the front surface 13u of the liquid crystal section 13. In this embodiment, only the display area 13a on the front surface 13a is exposed and the periphery 13b of the front surface 13u is covered at the side of the front surface 13u of the liquid crystal section 13. The spacer body 71 is provided along a periphery of the rear surface thereof with a lower positioning wall 73d for positioning the frame section 17 of the liquid crystal display device 3 and along a periphery of the front surface thereof with an upper positioning wall 73u for positioning the touch panel 5.

The portion 71a of the spacer body 71 that covers the liquid crystal section 13, as shown in FIGS. 2 and 3, is provided on the rear surface 71d with a recess so that the portion 71a is spaced away from the liquid crystal section 13. For example, a distal end 71b of the rear surface 71d is concaved. The portion 71a is provided on the front surface 71u with a recess so that the portion 71a is spaced away from the touch panel 5. For example, a distal end 71b of the front surface 71 is tapered. The lower positioning wall 73d of the spacer body 71, as shown in FIG. 2, engages the outer peripheral side surface of the frame section 17 of the liquid crystal display device 3. The frame section 17 is correctly positioned in the rear surface of the spacer body 71. Thus, the spacer member 7 is positioned correctly with respect to the front surface of the liquid crystal display device 3 so that the spacer member 7 does not extend over the display area 13a. The upper positioning wall 73u of the spacer body 71, as shown in FIG. 2, engages the outer peripheral side surface of the touch panel 5. The touch panel 5 is correctly positioned in the front surface of the spacer body 71. Thus, the spacer member 7 is positioned correctly with respect to the rear surface of the touch panel 5 so that the spacer member 7 does not extend over the action area 5a of the touch panel 5.

According to the touch panel apparatus 1 constructed above, the spacer member 7 covers the area from the front surface 17u of the frame section 17 of the liquid crystal display device 3 to a periphery 13b of the front surface 13u of the liquid crystal section 13 while maintaining the clearance between the spacer member 7 and the liquid crystal section 13 (without contacting the spacer member 7 with the liquid crystal section 13). It is possible to prevent lights from the illuminating section 15 from leaking through an outer periphery of the liquid crystal section 13 (for example, a clearance between the frame section 17 and the liquid crystal section 13) to a front side of the liquid crystal section 13, while preventing the liquid crystal section 13 from causing a failure in display on account of contact between the spacer member 7 and the liquid crystal section 13.

The portion 71 of the spacer member 7 that covers the liquid crystal section 13 is provided in the rear surface 71d with the recess for defining a clearance between the spacer member 7 and the liquid crystal section 13. A sufficient clearance can be defined between the spacer member 7 and the liquid crystal section 13. In particular, a sufficient clearance can be defined between the spacer member 7 and the liquid crystal section 13, even if the front surface 13u of the liquid crystal section 13 projects from the front surface 17u of the frame section 17. This prevents a contact between the spacer member 7 and the liquid crystal section 13.

The portion 71 of the spacer member 7 that covers the liquid crystal section 13 is provided in the front surface 71u with the recess for defining a clearance between the spacer member 7 and the touch panel 5. The portion 71 of the spacer member 7 that covers the liquid crystal section 13 can be prevented from being pushed rearward by the touch panel 5, even if the touch panel 5 is deflected rearward by a touch action. Consequently, the clearance can be defined between the spacer member 7 and the liquid crystal section 13 suitably, even if the touch panel 5 is deflected rearward.

The spacer member 7 is formed to expose only a display area 13a on a front surface 13u of the liquid crystal section 13 and to cover a periphery 13b of the front surface 13u. It is possible to surely prevent the lights from the illustrating section 15 from leaking through the outer periphery of the liquid crystal section 13 to the front side without lowering a visibility on the display area 13a on the liquid crystal section 13.

The lower positioning wall 73d projects from a rear surface of the spacer member 7 to engage the outer peripheral side surface of the frame section 17 of the liquid crystal display device 3. This can position the frame section 17 with respect to the rear surface of the spacer member 7. It is possible to dispose the spacer member 7 between the liquid crystal display device 3 and the touch panel 5 so that the spacer member 7 is positioned with respect to the front side of the liquid crystal display device 3.

The upper positioning wall 73u projects from the front surface of the spacer member 7 to engage an outer peripheral side surface of the touch panel 5. This can position the touch panel 5 with respect to the front surface of the spacer member 7. The spacer member 7 can be disposed between the liquid crystal display device 3 and the touch panel 5 so that the spacer member 7 is positioned with respect to the rear side of the touch panel 5.

The entire disclosure of Japanese Patent Application No. 2003-052952 filed on Feb. 28, 2003 including the specification, claims, drawings and summary is incorporated herein by reference in its entirety.

While the present invention has been particularly described, in conjunction with a specific preferred embodiment, it is evident that many alternatives, modifications, and variations will be apparent to those skilled in the art in light of the foregoing description. It is therefore contemplated that the appended claims will embrace any such alternatives, modifications, and variations as falling within the true scope and spirit of the present invention.

What is claimed is:

1. A touch panel apparatus comprising:
a liquid crystal display device including
a liquid crystal section,
an illuminating section disposed at a rear side of said liquid crystal section for illuminating said liquid crystal section, and
a frame section disposed on an outer periphery of said liquid crystal section;
a transparent resistive membrane type of touch panel disposed at a front side of said liquid crystal display device; and
a spacer member disposed between said frame section of said liquid crystal display device and a periphery of said touch panel for defining a clearance between said liquid crystal section of said liquid crystal display device and said touch panel;
wherein said spacer member covers an area from a front surface of said frame section of said liquid crystal display device to a periphery of a front surface of said liquid crystal section while maintaining said clearance between said liquid crystal section and said liquid crystal display device.

2. The touch panel apparatus according to claim 1, wherein a portion of said spacer member that covers said liquid crystal section is provided in a rear surface with a recess for defining a clearance between said spacer member and said liquid crystal section.

3. The touch panel apparatus according to claim 1, wherein a portion of said spacer member that covers said liquid crystal section is provided in a front surface with a recess for defining a clearance between said spacer member and said touch panel.

4. The touch panel apparatus according to claim 1, wherein said spacer member is formed to expose only a display area on a front surface of said liquid crystal section and to cover a periphery of said front surface.

5. The touch panel apparatus according to claim 1, wherein a lower positioning wall projects from a rear surface of said spacer member to engage an outer peripheral side surface of said frame section of said liquid crystal display device, thereby positioning said frame section with respective the rear surface of said spacer member.

6. The touch panel apparatus according to claim 1, wherein an upper positioning wall projects from said front surface of said spacer member to engage an outer peripheral side surface of said touch panel, thereby positioning said touch panel with respective the front surface of said spacer member.
